(19) United States
(12) Patent Application Publication
(10) Pub. No.: US 2013/0188817 A1
(43) Pub. Date: Jul. 25, 2013

(54) Extended Speakerphone Layout for Conference Room Tables

(71) Applicants: Peter Chu, Lexington, MA (US); Jeff Rodman, San Francisco, CA (US); Gopal Paripally, North Andover, MA (US)

(72) Inventors: Peter Chu, Lexington, MA (US); Jeff Rodman, San Francisco, CA (US); Gopal Paripally, North Andover, MA (US)

(73) Assignee: POLYCOM, INC., Pleasanton, CA (US)

(21) Appl. No.: 13/353,450

(22) Filed: Jan. 19, 2012

(51) Int. Cl. H04R 1/02

(52) U.S. Cl. 381/332

(57) ABSTRACT

A telescoping microphone and speaker strip for use in teleconferencing. The strip fitting a variety of different sized conference tables. The strip comprises a number of microphones and speakers placed on the median of a conference table and collapsed or extended to provide optimal maximum distances from participant to speaker and from participant to microphone while hiding all of the individual speaker and microphone wires. The strip can allow internal speaker and microphone wires to be retracted internally by a retracting mechanism. The strip is also wired or wirelessly connected to a base unit which provides telephonic audio signals, power, and signal processing to the strip.

### BACKGROUND OF THE INVENTION

1. Field of the Invention

This invention relates to teleconference and speakerphone systems.

2. Description of the Related Art

Teleconferencing has long been an essential tool for communication in business, government and education. There are many types of teleconferencing equipment based on many characterizations. One type of teleconference unit is a speakerphone, which typically includes at least a loudspeaker and a microphone in a single unit located on a central base.

Many conference tables are 4 foot by 8 foot or larger. Single-unit speakerphones are often placed in the middle of a conference table when used for a teleconference. This arrangement can leave some participants farther than four feet from the speakerphone. Participants seated farther away than three feet from the speakerphone, however, experience poor quality audio when both transmitting and receiving.

One solution for decreasing the distance from participant to microphone has been to place individual microphones near each participant. This solution, however, has its own problems. First, such solutions usually involve running wires from the central unit across the table. Not only is this cumbersome, but the wires often get tangled and the solution is unsightly.

A solution to having tangled wires has been to use individual wireless microphones. Such microphones can be placed close to the participant, but these microphones are easily lost. The batteries in the wireless microphones must be replaced or recharged often and may stop transmitting at inopportune moments during the teleconference. Additionally, managing interference between the various microphone transmitters poses other audio quality difficulties.

None of these solutions address the distance from participant to speaker. Although speaker distance is less critical than microphone distance, it is also a significant factor in the audio quality of a teleconference.

Another solution is a fixed voice system where microphones are installed in the table at fixed locations and multiple loud speakers are positioned as desired. But this solution is inflexible and very expensive and thus not suitable for widespread use.

It is therefore desirable to provide a robust and low maintenance solution to reduce the maximum distance from participant to microphone and participant to speaker while keeping the conference table clear of cluttering wires and that can be easily deployed.

### BRIEF SUMMARY OF THE INVENTION

Using the embodiments according to the current invention, most conference tables can be easily set up for teleconferencing. A telescoping speaker and microphone strip (“strip”), set up to an appropriate length for the conference table, affords each conference participant increased audio quality.

The strip has speaker sections and microphone sections that can be extended or retracted to optimize the distance between each conference participant and a system microphone and speaker. The strip can be placed down the center of a conference table where conference participants gather for a meeting. The strip may also be used on tables of varying sizes; however, in different embodiments, the strip has different numbers of speakers and microphones. The microphones may be directional or non-directional and may include one or more microphones per microphone section.

To keep the wires connecting the microphones and the speakers together and from becoming tangled, a retracting spool or other mechanism can be used in at least one of the sections to keep the wires from binding during extension and retraction of the strip.

A base unit connected to the strip provides audio signals, signal processing, and power to speaker amplifiers and signal processing circuits. The base unit may be connected to the strip directly, by wires, or connected wirelessly.

### BRIEF DESCRIPTION OF THE DRAWINGS

A better understanding of the invention can be had when the following detailed description of the preferred embodiments is considered in conjunction with the following drawings, in which:

FIGS. 1A-1C depict typical seating arrangements around various-sized conference tables.

FIGS. 2A-2E depict various placements of a speaker and microphone strip according to the present invention on the typical conference tables shown in FIG. 1.

FIG. 3 depicts the top view of a speaker and microphone strip according to the present invention.

FIG. 4 depicts a crossectional end view of a speaker and microphone strip according to the present invention.

FIG. 5 depicts a cut-away side view of a speaker and microphone strip according to the present invention.

FIG. 6 depicts a first block diagram of a speaker and microphone strip connected to a base unit according to the present invention.

FIG. 7A depicts a second block diagram showing an alternate schematic configuration of the base unit and the speaker and microphone strip according to the present invention.

FIGS. 7B and 7C are block diagrams of the microphone and speaker modules of the strip of FIG. 7A.

### DETAILED DESCRIPTION OF THE INVENTION

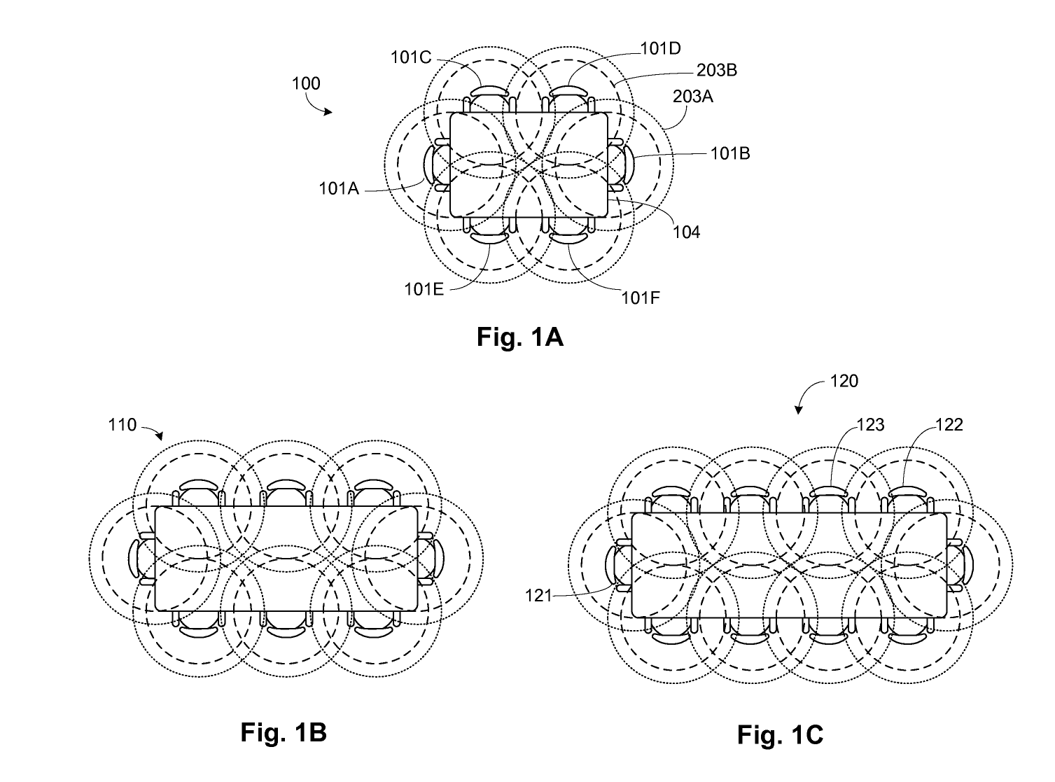

FIGS. 1A-1C illustrate typical seating arrangements at various sized conference tables. FIG. 1A shows a seating arrangement 100 that has six positions 101A-101E situated around a conference table 104. Table 104 could be a 4′×6′, 4′×8′, or other dimensioned table. The table illustrated in FIG. 1A is scaled to be approximately 4′×6′. FIG. 1B shows an eight-position seating arrangement no, scaled to represent a 4′×10′ table. FIG. 1C shows a ten-position seating arrangement 120 scaled to represent a 4′×12′ table. The seating arrangements have chairs for conference participants at end positions 121, corner positions 122, and middle positions 123. A two foot radius circle 203B is drawn about a point at the edge of the table at the center of each chair. This is the preferred maximum distance of a participant from a microphone. The preferred maximum distance from a speaker is slightly more at 2.5 feet and is the outer circle 203A of the concentric circles 203A and 203B.

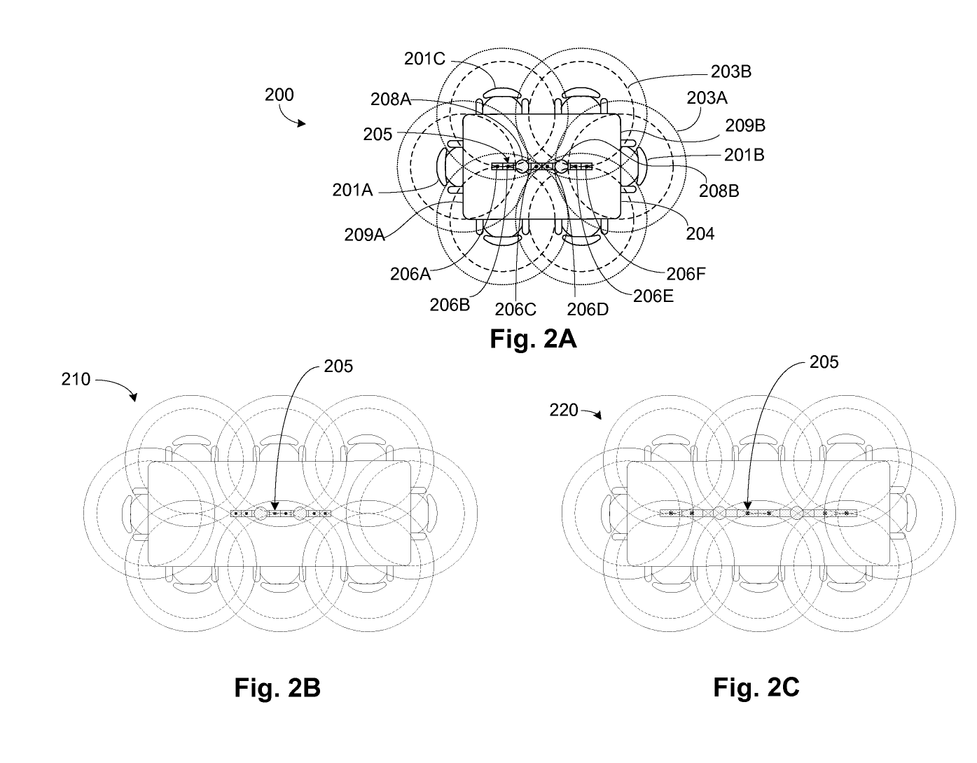

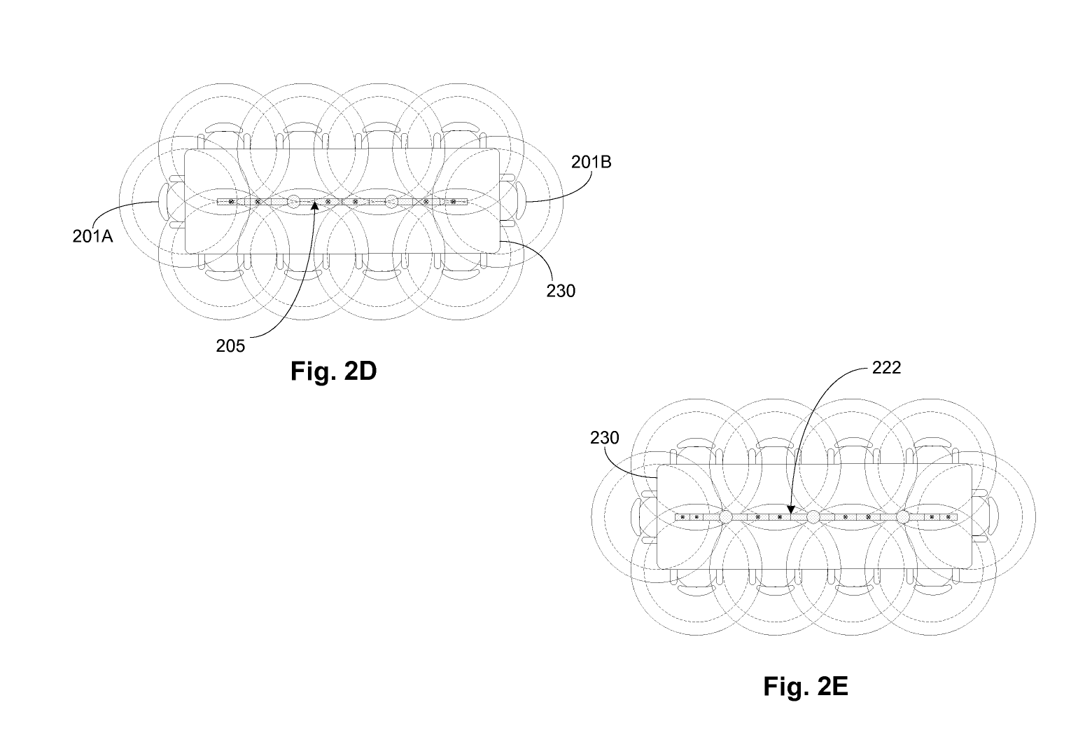

FIG. 2A illustrates a six-position seating arrangement 200 with one embodiment of the invention. A telescoping speaker and microphone strip (“strip”) 205 is placed on the median of the table 204. This embodiment of the invention has six microphone sections 206A-206F and two speaker sections 208A, 208B. A different number of speaker sections 206 and microphone sections 208 may be used as desired and as is appropriate for the size of the table.

The sections 206 and 208 may be retracted or telescoped to provide the desired microphone/speaker to participant distance 203. One of the reasons that this is advantageous, is that one strip may be used on different tables of varying length. By placing a system microphone or speaker closer to a conference participant, the audio experience is improved over systems that have the speakers or the microphones further away. In a preferred embodiment, the distance 203 from a seating position 101 is 2.5 feet or less from a speaker and 2 feet from a microphone, as mentioned above. The retractable and telescoping nature of the sections 206 and 208 allow a given strip to be used on various size tables, thus increasing flexibility and reducing needed variants.

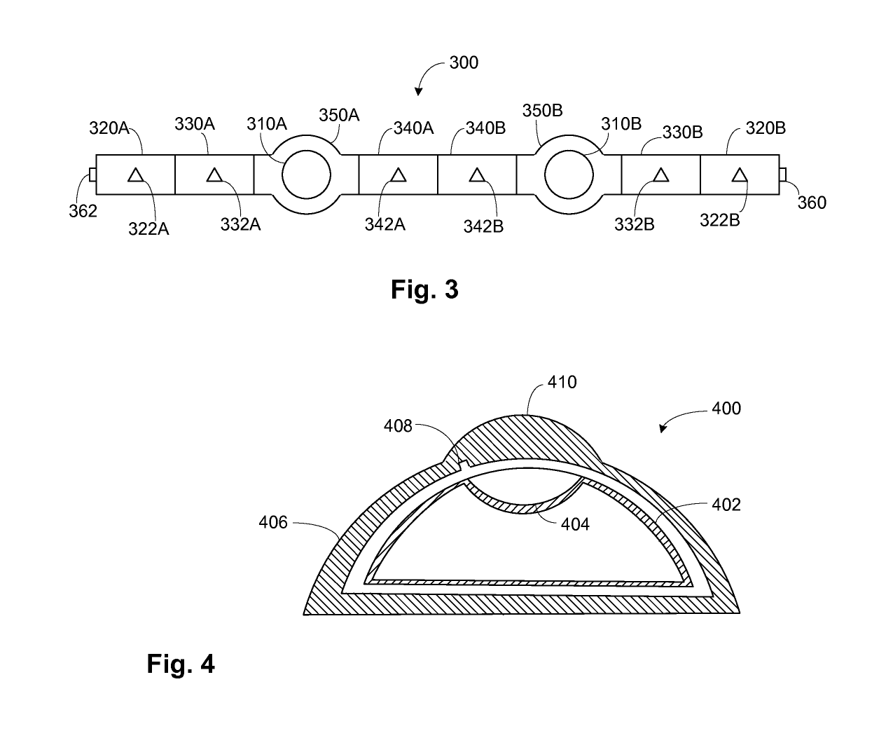

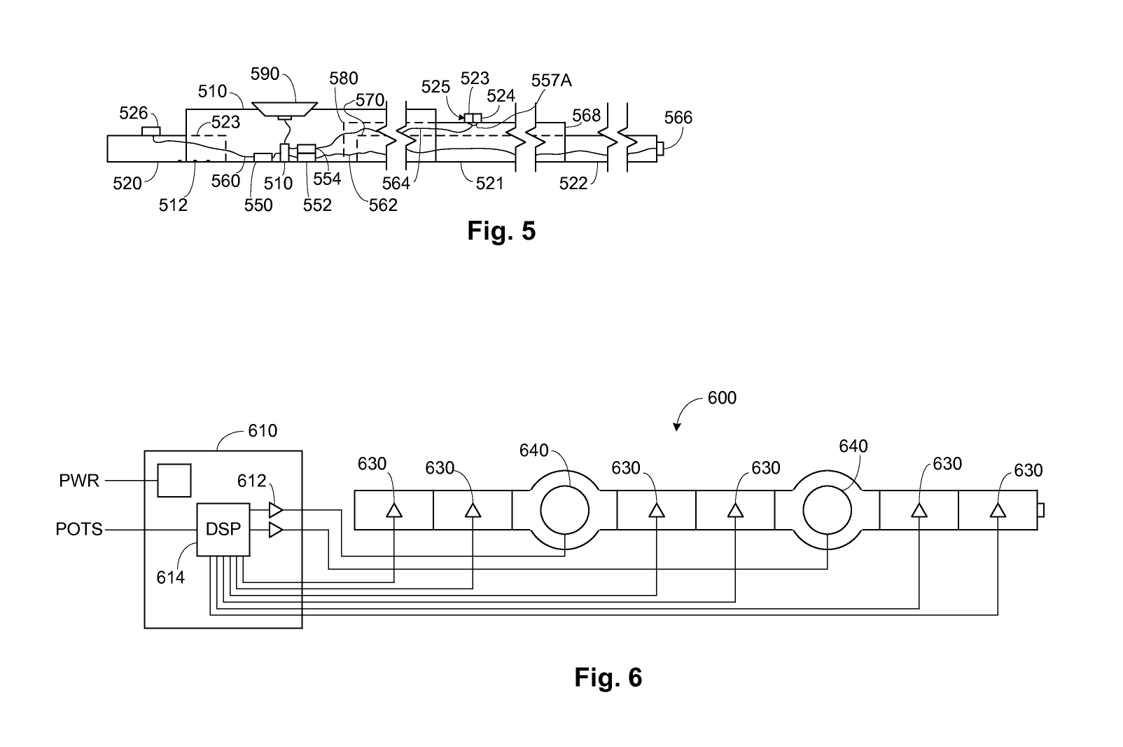

In the embodiment of FIG. 2A, the table 204 is 4′×6′. In this embodiment, microphone 526 (FIG. 5) in microphone section 206A is situated approximately 16 inches from an end edge 209A of the table 204 nearest participant position 201A; speaker 310A (FIG. 3) is situated two feet from the same edge 209A in speaker section 208A; and a microphone pair 525 (FIG. 5) is situated 34 inches from the same table edge 209A in microphone section 206B. Microphones and speakers are similarly spaced from the opposite table edge 209B and position As can be seen, at least one microphone is within the preferred 2 foot radius of each table position and a speaker is with the preferred 2.5 foot radius of each table position.

FIG. 2B shows an eight-position conference table arrangement 210. This figure illustrates the strip 205 from FIG. 2A as configured for table 204 placed directly on the larger conference table, the table 216 being a 4′×10′ table. In this, FIG. 2B strip 205 is not yet extended so as to have microphones and speakers near each position. As can be seen, the participants at each end and the corners of the table 216 are well outside the desired distance 203B from a microphone.

FIG. 2C shows an embodiment of the invention where the strip 205 has been extended to better equalize the distance 203 between the positions 101 and the microphone sections 206 and the speaker sections 208. In this embodiment, the strip 205 contains the same two speaker sections 208 and six microphone sections 206 as in FIG. 2A. Speaker sections 208 are slightly farther than the defined 2.5 feet for certain positions. However the microphones 206 are all within the desired two feet. This arrangement is acceptable as the speaker distance 203A is not as critical as the microphone distance 203B.

A ten-position 4′×12′ conference table 230 arrangement is shown in FIG. 2D. The strip 205 in this embodiment has two speaker sections 208 and six microphone sections 206 in the same extension as in FIG. 2C. As can be seen, the speakers 208 are now quite far from the end positions 201A, 201B, though the microphones are generally close to the two foot distance 203B. FIG. 2E illustrates a strip 222 with three speaker sections 208 and eight microphone sections 206 on this longer table 230. The strip 222 provides the desired distances 203. Therefore, while a given strip can be used on various size tables, at some point the distances may simply be too far and a different strip with more microphones and speakers must be used, but such longer tables are not as common as the 6, 8, and 10 foot tables which work with the strip 205, for example. It may be possible to collapse strip 222 to fit the shorter tables, but the increased cost of strip 222, as compared to strip 205, due to the additional components, does not make this a preferred solution. To fit a longer table, strip 222 may be further extended, thus handling the longest commonly available tables.

FIG. 3 shows one embodiment of a speaker and microphone strip 300. This embodiment contains two speaker sections 350A, 350B and six microphone sections 320A, 320B, 330A, 330B, 340A, and 340B. Each of the microphone sections 320, 330, and 340 has a microphone 322, 332, and 342 respectively. The microphones 322, 332, and 342 may be a single microphone 526, a microphone pair 525, or a number of microphones. The microphones could be directional or non-directional microphones. The speaker sections 350 each have a speaker 310. Alternatively, the microphone section could contain no microphone and the section is used for spacing the other sections.

The microphone sections 320, 330, and 340 may be telescoping or fixed with respect to speaker sections 310A and 310B but are telescoping with respect to adjacent microphone sections.

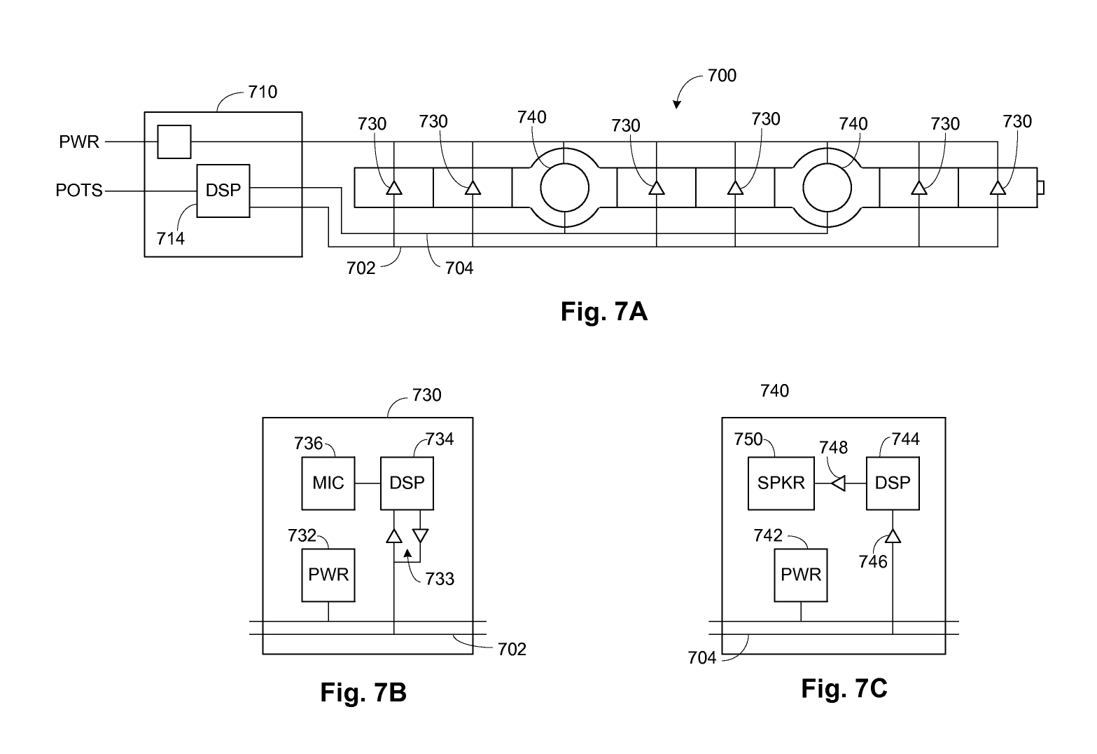

The strip 300 may have a connector 360 that is used to connect to another strip, such as strip 205, 222, 232, 300, 500. The strip 300 has a connector 362 to connect to a base unit 610(FIG. 6), 710 (FIG. 7). Preferably the connectors 360 and 362 are similar to allow daisy-chaining of strips if desired. The connectors 360, 362 connect the bundled signal wires 562, and in some embodiments, carries power to other circuitry such as digital to analog (D/A) converters, analog to digital (A/D) converters, signal processors, microcontrollers, or amplifiers. The signal wires 562 between the connectors 360, 362 and the wires connecting their associated microphones and speakers 560, 564, are all contained within the strip housing in the preferred embodiment. By having these wires covered, the strip 300 has a neat, uncluttered appearance at any extension or retraction amount.

FIG. 4 shows the telescoping sections 400 from the end of the strip 300. In this embodiment, telescoping sections 402 and 406 are cross-sections of microphone sections 320A and 330A respectively. The outer telescoping section 406 holds a microphone 322A in a convex housing 410. The inner telescoping section 402 holds a microphone 332A in a concave housing. The shape of the housings 404, 410 are such that the sections 402, 406 may be retracted completely while allowing the microphones 322A, 332A to have enough exposure to be effective when extended. The outer telescoping section 406 preferably has a notch 408 for guiding the microphone signal wires 560 to prevent interference with extension and retraction. Preferably sections 402 and 406 have a friction fit to study in place and counteract any retraction forces. The illustrated semicircular profiles are exemplary and other profiles can be used as desired.

FIG. 5 details another embodiment of a strip 500. The strip 500 is shown in this embodiment as having a speaker section 510 with a speaker 590; a telescoping section 520 with a microphone 526; a second telescoping section 521 with a microphone pair 525; and a third telescoping section 522 for connecting to another strip section 500 or to a base unit 610 via a connector 566. In other embodiments, where there is no need for a third telescoping section 522, connector 566 can be placed at the end of telescoping section 521. In yet another embodiment, telescoping section 521 has a microphone at the end 568 of telescoping section 521 and is connected directly to another end 568 of another strip (not shown).

The telescoping section 520 is shown partially extended. Section 520 is able to retract fully into position 523 or to intermediate positions. Detents 512 are placed to provide intermediate locking positions if desired. All of the extendable sections may have detents 512 in addition to or in replacement of a friction fit of the sections. The intermediate locking positions can be placed at positions associated with different size tables to make it simpler to transfer the strip from one size table to another.

The signal wire bundle 560 connected to microphone 526 is retracted by a retracting spool 550 that keeps tension on the wire bundle 560 such that the wire bundle 560 does not bind during extension and retraction. Similarly, signal wire bundle 564 is connected to microphone pair 525 and retracted by retracting spool 554. The multiple individual wires connecting to the microphones 523, 524 are bound together into a single wire bundle at 557A. This allows the spool 554 to more easily retract the wire bundle 564 without snagging the wire bundle 564 if it was not under tension. Similarly, the wire pair going to microphone 526 is bound at 557B. Also similarly, the wires connecting the speaker 590 are bundled with wire bundles 560 and 564 to form a third wire bundle 562. Retracting spool 552 keeps tension on wire bundle 562. In some embodiments, the spools may be stacked vertically as shown for spool 554in FIG. 5. To save vertical space, the spools may also be mounted along the bottom of the strip. The retracting spools are one example to manage the various wires present in a strip. Other techniques as known to those in the art can also be used.

In this embodiment, microphone pair 525 is made of two directional microphones 523 and 524. Each microphone is focused perpendicularly to the length of the strip 500 and point in opposite directions. In another embodiment, an omnidirectional or multidirectional microphone may be used in place of microphone pair 525. A mechanical dampener (not shown) supports each microphone to attenuate extraneous table noises such as fingers or pens tapping on the conference table. Polycom VTX 1000 microphones and speakers may be used as the microphones 523, 524, 526 and speaker 590, though particular microphone and speaker selection is very embodiment dependent, with numerous options available.

A base unit typically houses a telephone line interface and, in some instances, a power converter used to supply signal processing circuits and amplifiers. There are many ways to connect a strip 600 to a base unit 610. FIG. 6 shows how the strip 600 may be connected through base unit 610, which is connected to a power source and either a Plain Old Telephone service (POTS) network or an IP network, or both. In this embodiment, a signal control module 614, such as a DSP, receives the IP or POTS signal and may perform various signal processing algorithms, such as echo cancellation and like, before sending the audio signals to amplifiers 612 to drive the speakers 640. The signal control module 614 also receives input from the microphones 630 and may perform various signal processing algorithms, such as selection or mixing of the various microphone signals, on the microphone input signals before sending them on to the network. Wires running from the strip 600 to the base 610 are bundled to keep a neat and uncluttered connection. In the embodiment shown in this figure, each microphone 630 sends a separate signal to the signal control module 614 and each speaker 640 is driven by amplifiers 612 located in the base unit 610. An advantage of the method shown in this embodiment is that only telephone signal wires need to be routed to the strip 600. This alleviates the need to put amplifiers in the strip or run power wires to the strip. This does, however, cause the greatest number of wires needed to be run from the strip 600 to the base unit 610. To further reduce the number of wires running from strip to base unit, some or all of the microphones or speakers may be wired in parallel.

To reduce the number of wires needed to be run from the strip to the base unit, a digital microphone bus 702 for use with digital microphone modules 730 (FIG. 7B) and/or a digital speaker bus 704 for use with digital speaker modules 740 (FIG. 7C) may be employed in the system shown in FIG. 7A. In such embodiments, the signals from the microphone modules 730 and signals going to the speaker modules 740 are digitized and processed by the signal control module 714. Using a digital bus interface reduces the number of signals that are required to be sent to and from the base unit. In a preferred embodiment, the strip 700 is connected to the base unit 710 by the digital signal buses and power wires.

FIG. 7B illustrates an exemplary digital microphone module 730. A power supply 732 provides power to the components in the module 730. A DSP 734 is connected to the microphone bus 702 via bi-directional buffers 733 to receive commands from the base unit 710 and to provide audio to the base unit 710. A microphone 736 is connected to the DSP 734. The DSP 734 performs the simple signal processing functions for the analog to digital conversions for the microphone signals and handles the microphone bus 702 protocol.

FIG. 7C illustrates an exemplary digital speaker module 740. A power supply 742 provides power to the components in the module 740. A buffer 744 connects the digital speaker bus 704 to a DSP 744. The DSP 744 handles the protocol and converts the digital signals to an analog speaker signal provided to an amplifier 748 which drives a speaker 750.

In other embodiments, the strip is connected to the base unit wirelessly using any number of wireless technologies. For example, analog or digital RF technology using 900 MHz or 2.4 GHz frequency band commonly used in cordless telephones may be used. IEEE 802.11 Wi-Fi technology may be used. The mature digital Wi-Fi technology can provide many functions with very little incremental cost. Bluetooth, which is now widely used in consumer electronic devices, may also be used for communication between the base unit and the strip. Both have the advantage of being able to move the base with respect to the strip freely. Either the base or the strip may be powered by a battery or by regular wall outlet.

While the illustrated embodiments show a single microphone location in each section, multiple microphone locations can be used to provide additional extension capability.

The embodiments of the current invention provide methods and devices to put microphones and speakers in a more optimal placing on any conference table without the need to cope with cumbersome and unsightly speaker and microphone wires on the table. The telescoping nature of the invention allows it to be placed on a variety of table sizes while still maintaining good audio quality for conferencing. The embodiments of the current invention improve and expand functionalities and features of teleconference units and speakerphones.

While illustrative embodiments of the invention have been illustrated and described, it will be appreciated that various changes can be made therein without departing from the spirit and scope of the invention.

We claim:

1. A teleconferencing speaker and microphone strip comprising:
a first speaker section having at least one speaker; and
a first microphone section having at least one microphone,
wherein said first microphone section and said first speaker section are interconnected to telescope with respect to each other for changing the length of the strip.

2. The strip of claim 1, further comprising:
a second microphone section having at least one microphone, said second microphone section interconnected to said first speaker section to telescope with respect to each other, for changing the length of the strip,
wherein said first and second microphone sections are on opposing sides of said first speaker section.

3. The strip of claim 2, wherein said at least one microphone in either or both of said first microphone section or said second microphone section includes a microphone pair, wherein the microphone pair includes two microphones facing in opposite directions.

4. The strip of claim 2, further comprising:
a second speaker section containing at least one speaker; and
a third microphone section containing at least one microphone, said third microphone section interconnected to said second speaker section to telescope with respect to each other,
wherein said second and third microphone sections are on opposing sides of said second speaker section.

5. The strip of claim 1, further comprising:
a plurality of signal wires, at least one signal wire connected to said first microphone signal and at least one signal wire connected to said first speaker section.

6. A teleconferencing system comprising:
a speaker and microphone strip including:
a first speaker section having a first speaker, and
a first microphone section having at least one microphone,
wherein said first microphone section and said first speaker section are interconnected to telescope with respect to each other for changing the length of said speaker and microphone strip; and
a base unit including a signal processing circuit and connected to said speaker and microphone strip.

7. The teleconferencing system of claim 6, said speaker and microphone strip further including:
a second microphone section having at least one microphone, said second microphone section interconnected to said first speaker section to telescope with respect to each other, for changing the length of said speaker and microphone strip,
wherein said first and second microphone sections are on opposing sides of said first speaker section.

8. The teleconferencing system of claim 7, wherein said at least one microphone in either or both of said first microphone section or said second microphone section includes a microphone pair, wherein the microphone pair includes two microphones facing in opposite directions.

9. The teleconferencing system of claim 7, said speaker and microphone strip further including:
a second speaker section containing at least one speaker; and
a third microphone section containing at least one microphone, said third microphone section interconnected to said second speaker section to telescope with respect to each other,
wherein said second and third microphone sections are on opposing sides of said second speaker section.

10. The teleconferencing system of claim 6, said speaker and microphone strip further including:
a plurality of signal wires, at least one signal wire connected to said first microphone signal and at least one signal wire connected to said first speaker section,
wherein said plurality of signal wires are connected to said base unit processing circuit.
